(19) United States
(12) Patent Application Publication
(10) Pub. No.: US 2004/0049430 A1
(43) Pub. Date: Mar. 11, 2004

(54) Oder resurrection

(76) Inventors: George Redenbaugh, San Jose, CA (US); Richard York, San Jose, CA (US); Niraj Kanthi, Sunnyvale, CA (US); Cynthia A. Zelanis, Santa Clara, CA (US); Juan Juan Xu, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/241,197

(22) Filed: Sep. 11, 2002

(51) Int. Cl. G06F 17/60

(52) U.S. Cl. 705/26

(57) ABSTRACT

A method of resurrecting a cancelled order, includes: in response to a cancelled order, receiving a request to resurrect the cancelled order; determining if the cancelled order is eligible for resurrection; if the cancelled order is eligible for resurrection, then gathering additional information to make a recommendation on the resurrection or denial of resurrection of the cancelled order; and analyzing the request in order to grant or deny the resurrection of the cancelled order.

### TECHNICAL FIELD

Embodiments of the present invention relate generally to the fraud prevention methods. More particularly, embodiments of the present invention provide an apparatus, system, and method for order resurrection by call center associates.

### BACKGROUND

Currently, the order resurrection process is manual, in the case for fraud decline orders. When a call center associate receives a request for the order resurrection, the associate sends the order information to the fraud team by facsimile. Sometimes, the associate may place a new order, instead of resurrecting the original order.

The above-mentioned current process has various problems. First, the manual process is time consuming. In particular, the manual process may not give sufficient time to resurrect an order, if resurrection is required within, for example, seventy-two (72) hours from the time the pre-authorization is approved.

Second, the current order resurrection process does not maintain a history of the order, to indicate that the given order was previously rejected by, for example, the eFalcon e-commerce fraud detection product from Fair, Issac and Company, San Rafael, Calif., and that the order was subsequently resurrected. A history of the order would be helpful for a fraud detection team.

Third, if an associate places the new order, the fraud detection team will not be able to track the new order. This creates a problem for customer profiling. Also, there are high chances that the new order may also be rejected since the customer profile will be typically the same on both orders.

Additionally, if the original order is placed by one associate and another associate places the new order, then the associate placing the new order does not receive inventory or other information about the new order. This creates several issues related to inventory tracking and to giving origination credits to associates for obtaining customer orders.

Therefore, current technologies are limited in their capabilities and suffer from at least the above constraints.

### SUMMARY OF EMBODIMENTS OF THE INVENTION

In one embodiment, the invention provides a method of resurrecting a cancelled order, including:

in response to a cancelled order, receiving a request to resurrect the cancelled order;

determining if the cancelled order is eligible for resurrection;

if the cancelled order is eligible for resurrection, then gathering additional information to make a recommendation on the resurrection or denial of resurrection of the cancelled order; and

analyzing the request in order to grant or deny the resurrection of the cancelled order.

In another embodiment, the invention provides an apparatus for resurrecting a cancelled order, including:

a call center configured to receive a request to resurrect the cancelled order, determine if the cancelled order is eligible for resurrection, and gathering additional information to make a recommendation on the resurrection, or denial of resurrection of the cancelled order;

a resurrection request module configured to pass a request for resurrection and temporarily hold the request; and

a rule application module configured to permit analysis of the request.

In yet another embodiment, the invention provides a method of resurrecting an order for a product or service, including:

requesting, by a customer, for a resurrection of an order to a call center associate, where the order has been cancelled;

evaluating, by the call center associate, the request for the resurrection of the order by obtaining additional information from the customer to determine if the order should be recommended for resurrection;

placing, by the call center associate, the request on a queue, where a comment by the call center associate is provided with the request, with the comment indicating a recommendation to accept or decline the request for resurrection; and

reviewing, by a fraud team member, of a request for the resurrection of an order to determine if the request should be granted, where the request has been placed in the queue.

In yet another embodiment, the invention provides an apparatus for resurrecting an order for a product or service, including:

a view order status module configured to show a status of an order;

a resurrection request module configured to queue an order that has been requested for resurrection, where the resurrection request includes a comment indicating whether to accept or decline the resurrection request; and

a rule application module configured to accept, reject and purge a request for an order that has been stored in a queue in the resurrection request module.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (or apparatus) in accordance with an embodiment of the invention.

FIGS. 2 through 4 show a flowchart of a method of order resurrection, in accordance with an embodiment of the invention.

FIG. 5 is a computer display screen shot that indicates various information to a customer.

FIG. 6 is a computer display screen shot that permit a call center associates to enter comments in a comment field for a particular order that has been requested for resurrection by a customer.

FIG. 7 is a computer display screen shot that provide a status of an order to a customer.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

Embodiments of the invention provide various advantages such as, for example, allowing for the tracking of “false positives” (i.e., orders denied in error), preventing orders from being re-submitted and from evading the fraud screening process, and improving responses to customer orders and decreasing negative customer experience when placing orders. Other advantages made possible by embodiments of the invention includes, for example, the following: giving the customer, call center associates, and fraud team the visibility to the current status of second level requests to avoid duplicate orders and duplicate order escalations; automating the process of putting the resurrection request by the center associates, and informing the call center about which particular orders should be resurrected; reducing the duplicate orders; and providing the accurate order history to the fraud team.

An embodiment of the invention is implemented in, for example, the product name (or service name) hpshopping business application which is provided by Hewlett-Packard Company, Palo Alto, Calif.

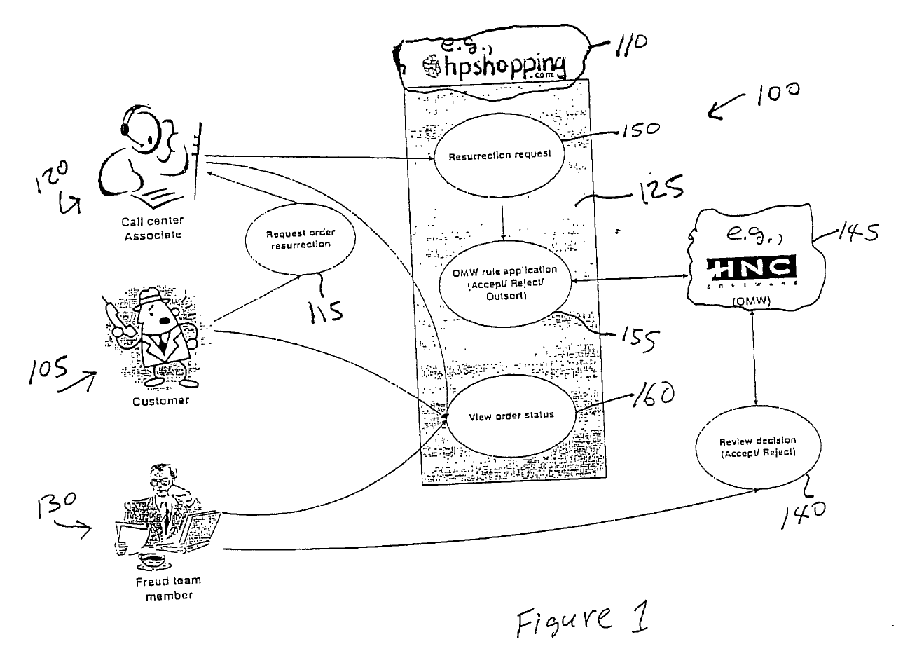

FIG. 1 is a block diagram of a system (or apparatus 100) in accordance with an embodiment of the invention. A customer 105 may include, for example, a customer who logs on an online shopping website 110 (e.g., <www.HPShopping.com>) or an employee of a company (e.g., a Hewlett-Packard employee) who is accessing the online shopping site 110 (or an internal company shopping website). The customer 105 would use the on-line shopping website 110 for online shopping and/or order tracking. In an embodiment of the invention, such a customer 105 will request (115) the resurrection of an order to a call center associate 120 (in a call center) over the phone and provide particular information for identification and validation. A view order status module 160 permits the customer 105, call center associate 120, and fraud team member 130 can view the status of an order. A resurrection request module 150 permits the call center associate to request the resurrection of an order and also includes a queue for temporarily tracking orders that have been requested for resurrection. A rule application module 155 provides rules for accepting, rejecting and purging requests for orders that are stored in the queue in the resurrection request module 150. Additionally, a fraud detection software 145 (e.g., eFalcon) may be used to accept or reject a request for order resurrection and/or to permit a fraud team member 130 to review (140) a decision to accept or reject an order resurrection request. The modules 150, 155, and 160 may typically be implemented by use of software code.

In an embodiment, a call center associate will use an internal website 125 to evaluate the order resurrection request from the customer 105. Additional detail on a method of evaluating an order resurrection request is described below. After the call center associate evaluates an order resurrection request, the request will be outsorted and put in a queue (in module 150) for a fraud team member 130 to review manually. At this time, the order state should be “under review”. The fraud team member 130 can review outsorted order resurrection requests and take appropriate decisions on whether to accept or reject the order resurrection request. If the order resurrection request is accepted, then the order may typically flow through a suitable order fulfillment process. If the order resurrection request is rejected, then the order may typically flow through a suitable fraud rejection process. For example, if an order is rejected, then the customer 105 is sent an electronic mail (e-mail) message or phone call indicating that the order was requested for resurrection, but the order was declined. The message or phone call may optionally indicate that the customer 105 is requested to seek another vendor for the requested product and/or service associated with the order. Other suitable order fulfillment processes or fraud rejection processes may be used in an embodiment of the invention.

If a fraud team member(s) 130 is not be able to make a decision to accept or reject an order resurrection request within a given time frame or given time (e.g., by 7:00 PM on a weekday), then the order(s) is automatically rejected by the system 100, in accordance with an embodiment of the invention.

The system 100 typically tracks the event of a resurrection request for the order.

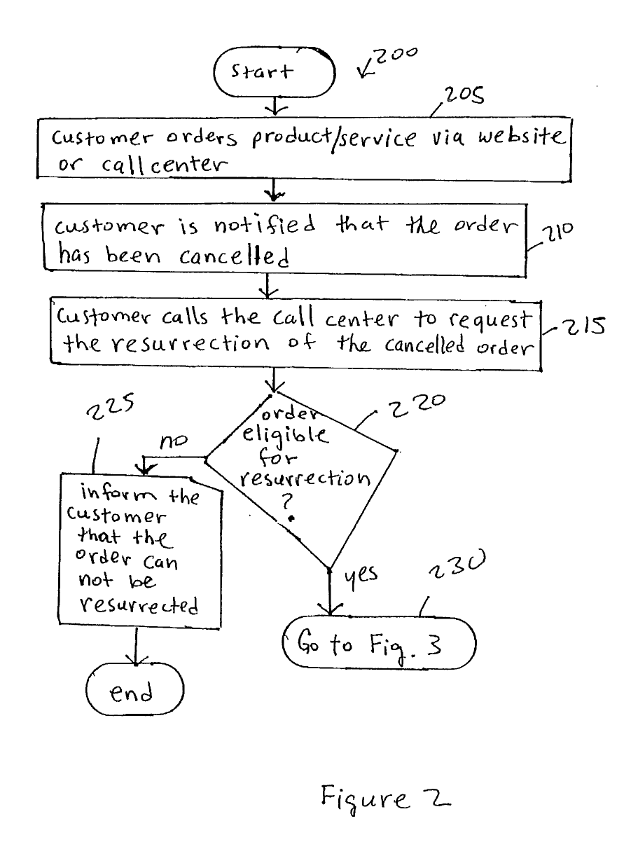

FIG. 2 is a flowchart of a method 200 of order resurrection, in accordance with an embodiment of the invention. A customer can order a product (e.g., a computer) or service by accessing an online shopping website or by calling a call center. Assume that the customer is then notified (210) that the order has been cancelled. Various possible reasons for having an order cancelled are described below. The customer may be notified of the order cancellation via an e-mail message from the online shopping website or via a phone call from the call center.

Assume that the customer subsequently calls (215) the call center in order to request the call center to resurrect the cancelled order. For example, if the customer is in need of a computer that is included in the cancelled order, then the customer may be motivated to call the call center in order to request the resurrection of the cancelled order. Alternatively, if the customer is fraudulently trying to obtain the product or service in the cancelled order, then the persistent fraudster may be motivated to call the call center to request the resurrection of the cancelled order.

The method 200 then checks (220) if the cancelled order is eligible for resurrection. If the order is not eligible for resurrection, then the customer is informed (225) via an e-mail message from the online shopping website or via a phone call from the call center that the cancelled order is not eligible for resurrection. The message or phone call to the customer may also request the customer to seek another vendor since the customer's order can not be resurrected.

Examples of an order that is not eligible for resurrection may include at least one of the following: (1) an order that has been cancelled due to a lack of funds or due to a credit limit of the customer; (2) an order that has been automatically cancelled by an address verification system; (3) an order to configure a machine or equipment. Additionally or alternatively, an order may be designated as not eligible for resurrection if the order was previously requested for resurrection at least one once. Thus, it is within the scope of embodiments of the invention to designate an order as eligible for resurrection even if the order was previously requested for resurrection.

In another embodiment, if an order that is not eligible for resurrection, then a replacement order can be made if, for example, at least one lead (or associate team lead or other designated individual) in the call center reviews the order that was not eligible for resurrection and approves the replacement order to replace the cancelled order.

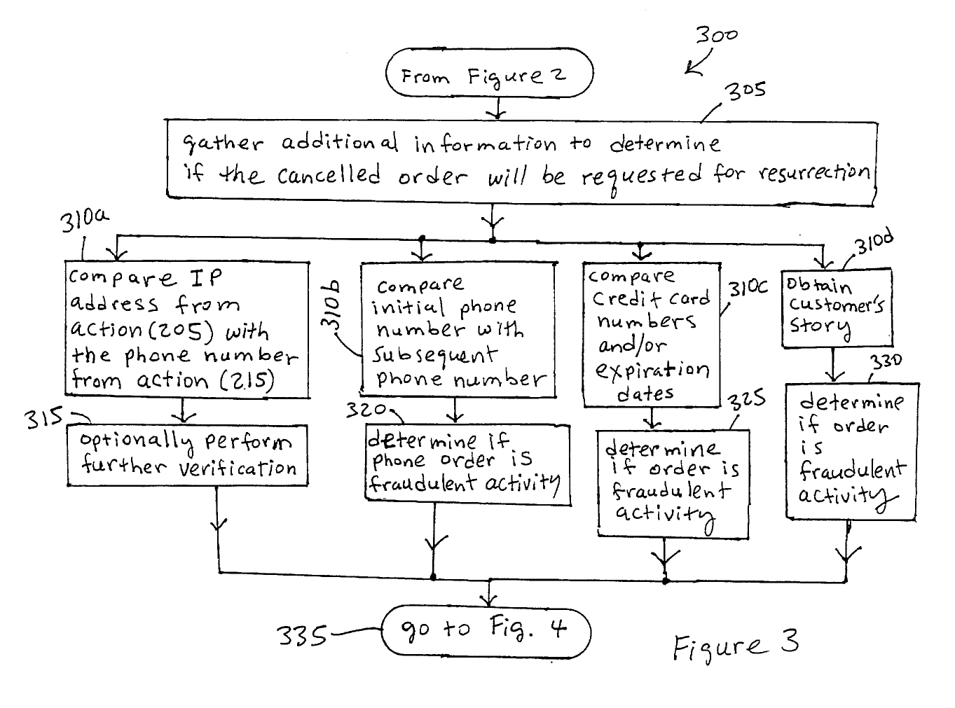

If the order is eligible for resurrection, then the method 200 proceeds to FIG. 3.

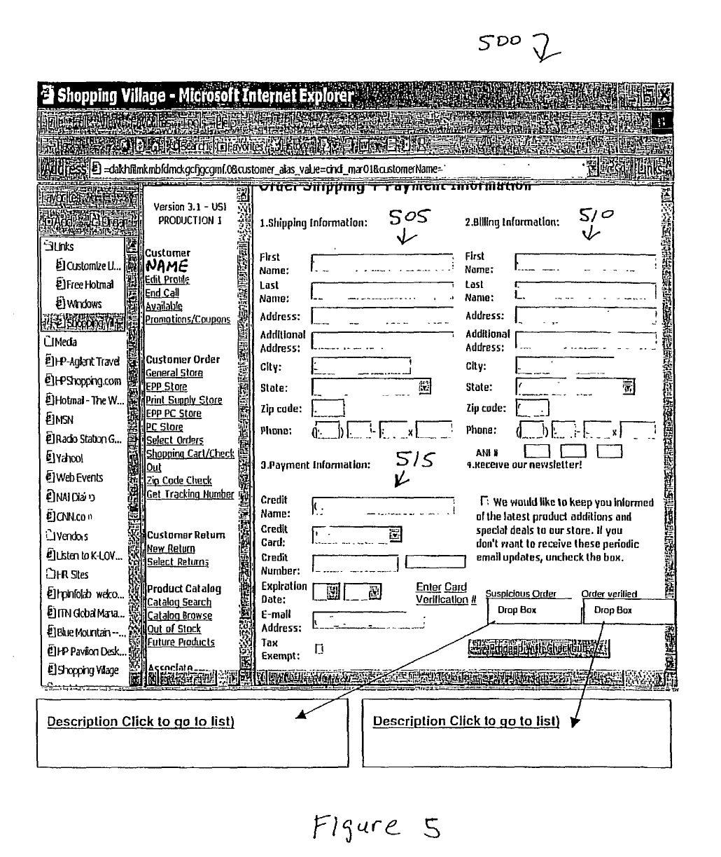

As shown in FIG. 3, the method 200 continues as method 300 to determine if a cancelled order will be resurrected. The call center associate will gather (305) additional information to permit the associate to determine if the cancelled order should be recommended for resurrection. In an embodiment of the invention, the call center associate can compare various information to determine if he/she will make a recommendation to resurrect the order. It is noted that FIG. 5 shows an example of a computer screen shot 500 where the customer provides various information when initially placing (205) an order. For example, fields 505 require the customer to enter shipping information. Fields 510 require the customer to enter billing information. Fields 515 require the customer to enter payment information.

As an example, if the customer initially placed (205) an order via an online shopping website, then the call center associate can compare (310a) the Internet Protocol (IP) address that the customer used to initially place the online order with the phone number (e.g., ANI number or auto-number identification) from which the customer is subsequently calling (215) the call center to request the resurrection of the cancelled order. Thus, if a customer from Company Y placed (205) an order by using an IP address assigned to Company Y and subsequently calls (215) the call center from a phone number assigned to Company Y to request the resurrection of the cancelled order, then the call center agent can optionally perform (315) further verification such as, for example, verifying the identity of the customer by calling Company Y to determine if the customer is an employee of Company Y and to determine if the customer's order is related to a fraudulent activity.

Alternatively, if the customer initially placed (205) an order by calling the call center, then the call center associate can compare (310b) the initial phone number (e.g., the initial ANI number) that the customer used to initially place the online order with the subsequent phone number (e.g., the subsequent ANI number) from which the customer is subsequently calling (215) the call center to request the resurrection of the cancelled order. Thus, as a specific example, if a customer called (215) from a number in San Diego, Calif. (as identified in, e.g., the initial ANI number) and subsequently calls (215) the call center from a number in Chicago (as identified in, e.g., the subsequent ANI number) to request the resurrection of the cancelled order, and if the subsequent call was placed (215) at about two hours after the initial call was placed (205), then the call center associate may make a determination (320) whether or not the phone order (customer's order) may be related to a fraudulent activity.

Additionally or alternatively, as a further safety check, the call center agent can request for the customer's credit card number and expiration date to make comparisons (310c). If the credit card number and/or expiration date does not match the credit card number and/or expiration date that was originally provided by the customer when the order was placed (205) via the online shopping website or via a phone call to the call center, then the associate can make (325) a determination whether or not the customer's order may be related to a fraudulent activity.

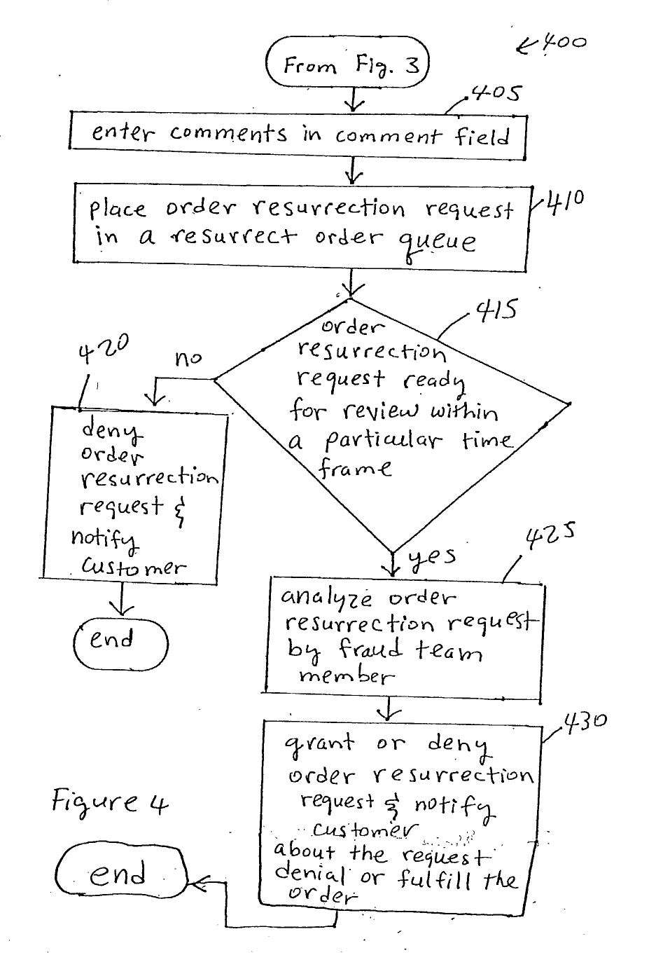

Additionally or alternatively, as a further check, the call center associate can obtain (310d) the customer's story that resulted in the order cancellation. For example, the customer may have mistyped or mis-stated his/her credit card number, credit card expiration date, phone number, shipping address, and/or billing address when he/she initially placed (205) an order. As another example, the customer may have indicated the shipping address as his/her business address or the address of his/her relative or family member, instead of the billing address for particular reasons such as reasons related to securely receiving any shipped ordered products. Thus, based on the customer's story, the call center associate can make (330) a determination whether or not the customer's order may be related to a fraudulent activity. For example, the call center associate can call the shipping address provided by the customer or can verify the credit card number provided by the customer in action (305). The method 300 then proceeds (335) to FIG. 4.

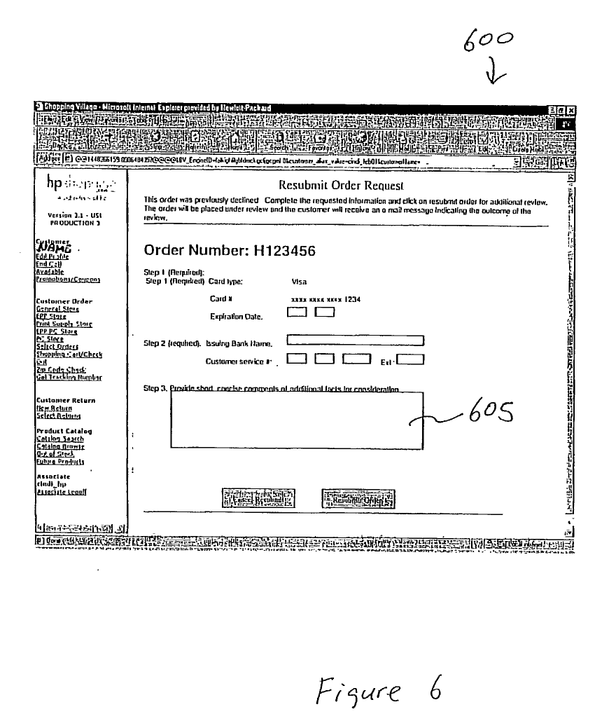

As shown in FIG. 4, the method 300 continues, as method 400 to determine if a cancelled order will be resurrected. Based on the call center associate's determination of whether or not there is potential fraudulent activity relating to the customer's order (by making the determination in action (315), (320), (325), and/or (330)), the call center associate will enter (405) comments in a comment field (typically a field length of about 250 characters) about circumstance(s) that led to the cancellation of the customer's order. The associate can enter the comments in, for example, the comments field 605 in the computer screen shot 600 in FIG. 6. As an example, comments may include (or indicate) a recommendation of the associated on whether to approve or decline the request for resurrection of the order.

The order resurrection request is then placed in a resurrect order queue (as implemented by module 150 in FIG. 1). The order resurrection request in the queue are required to be reviewed within a particular time or time frame (e.g., the request needs to be reviewed on or before 7:00 PM on a weekday). In action (415), the order resurrection request may or may not be ready for review within the particular time frame. If the order resurrection request is not ready for review, then the order resurrection request is denied (420) and the customer is notified that the order resurrection request can not be completed. The customer may be optionally notified to seek another vendor for the cancelled order.

If the order resurrection request is ready for review, then a fraud team member will analyze the order resurrection request. Based on the analysis of the order resurrection request, the fraud team member can grant or deny (430) the order resurrection request. The customer is notified if the order resurrection request has been granted or denied. Suitable order fulfillment processes or fraud rejection processes may be used to then fulfill the order or deny the order.

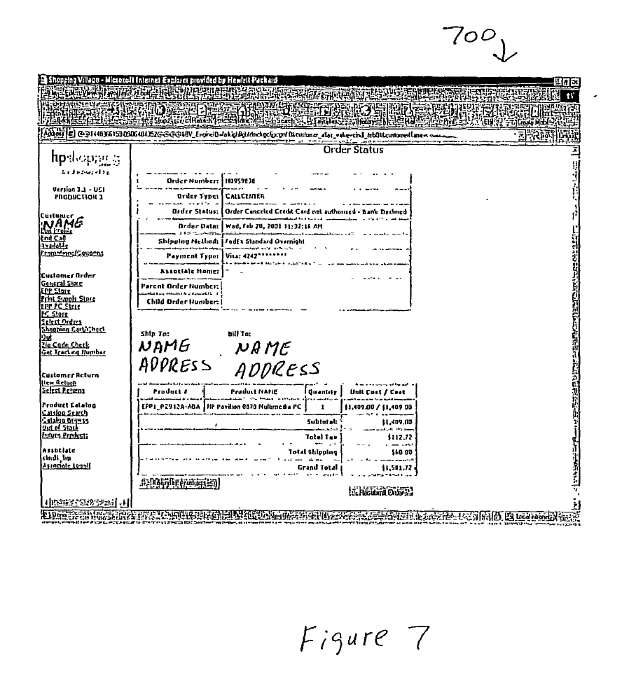

It is also noted that FIG. 7 shows an example computer screen shot 700 that permits a customer, call center associate or fraud team member to view the status of an order that has been requested by the customer for resurrection. The module 160 in FIG. 1 permits the order status to be shown by the screen shot 700.

Thus, in an embodiment, an order must go to the loss prevention team and be outsorted—the call center agent has no decision authority, and the agent(s) acts as the information gathering point. An agent submits the order resurrection request to the queue for review by a fraud team member.

When the order is rejected, the reason codes provided for the rejection dictate the information the associate needs to gather from the customer, and this information is then submitted into the system 100; the order is out sorted and reviewed by the loss prevention team 130 for a final decision.

The various engines or modules discussed herein may also be, for example, software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method of resurrecting a cancelled order, the method comprising:
in response to a cancelled order, receiving a request to resurrect the cancelled order;
determining if the cancelled order is eligible for resurrection;
if the cancelled order is eligible for resurrection, then gathering additional information to make a recommendation on the resurrection or denial of resurrection of the cancelled order; and
analyzing the request in order to grant or deny the resurrection of the cancelled order.

2. The method of claim 1, further comprising:
automatically denying the order resurrection request if the request is not analyzed within a particular time.

3. The method of claim 1, wherein a customer provides a request to resurrect the cancelled order.

4. The method of claim 1, wherein a call center agent gathers additional information to make the recommendation on the resurrection or denial of resurrection of the cancelled order.

5. The method of claim 1, wherein a fraud team member analyzes the request in order to grant or deny the resurrection of the cancelled order.

6. The method of claim 1, wherein the action of gathering additional information comprises:
comparing the gathered information with initial information provided by a customer during an initial placement of the order.

7. The method of claim 6, wherein the action of comparing the gathered information comprises:
comparing an initial Internet Protocol address with a subsequent phone number.

8. The method of claim 6, wherein the action of comparing the gathered information comprises:
comparing an initial phone number with a subsequent phone number.

9. The method of claim 6, wherein the action of comparing the gathered information comprises:
comparing an initially provided credit information with subsequently provided credit information.

10. The method of claim 6, wherein the action of comparing the gathered information comprises:
obtaining a customer story relating to the cancelled order.

11. The method of claim 1, further comprising:
providing comments after the action of gathering additional information.

12. The method of claim 1, further comprising:
placing the request in a queue after the action of gathering additional information.

13. The method of claim 1, wherein the action of receiving a request to resurrect the cancelled order is received in a call center.

14. An apparatus for resurrecting a cancelled order, the apparatus comprising:
a call center configured to receive a request to resurrect the cancelled order, determine if the cancelled order is eligible for resurrection, and gathering additional information to make a recommendation on the resurrection or denial of resurrection of the cancelled order;
a resurrection request module configured to pass a request for resurrection and temporarily hold the request; and
a rule application module configured to permit analysis of the request.

15. An apparatus for resurrecting a cancelled order, the apparatus comprising:
in response to a cancelled order, means for receiving a request to resurrect the cancelled order;
coupled to the receiving means, means for determining if the cancelled order is eligible for resurrection;
coupled to the determining means, means for gathering additional information to make a recommendation on the resurrection or denial of resurrection of the cancelled order if the cancelled order is eligible for resurrection; and
coupled to the gathering means, means for analyzing the request in order to grant or deny the resurrection of the cancelled order.

16. An article of manufacture, comprising:
a machine-readable medium having stored thereon instructions to:
in response to a cancelled order, receive a request to resurrect a cancelled order;
determine if the cancelled order is eligible for resurrection;
if the cancelled order is eligible for resurrection, then gather additional information to make a recommendation on the resurrection or denial of resurrection of the cancelled order; and
analyze the request in order to grant or deny the resurrection of the cancelled order.

17. A method of resurrecting an order for a product or service, the method comprising:
requesting, by a customer, for a resurrection of an order to a call center associate, where the order has been cancelled;
evaluating, by the call center associate, the request for the resurrection of the order by obtaining additional information from the customer to determine if the order should be recommended for resurrection;
placing, by the call center associate, the request on a queue, where a comment by the call center associate is provided with the request, with the comment indicating a recommendation to accept or decline the request for resurrection; and
reviewing, by a fraud team member, of a request for the resurrection of an order to determine if the request should be granted, where the request has been placed in the queue.

18. The method of claim 17, further comprising:
if the request is granted, then fulfilling the order.

19. The method of claim 17, further comprising:
if the request is not granted, then notifying the customer that the request for the resurrection of the order has been declined.

20. The method of claim 19, further comprising:
requesting the customer to seek another vendor for a product or service associated with the order.

21. The method of claim 17, further comprising:
purging a request for a resurrection of an order, where the request has been placed in the queue and has not been reviewed within a particular time frame.

22. The method of claim 17, further comprising:
tracking an event of a resurrection request for an order.

23. The method of claim 17, further comprising:
before evaluating the request, checking if an order is eligible of resurrection.

24. The method of claim 23, wherein an order is ineligible for resurrection if a predetermined number of previous requests for resurrection has been made for the order.

25. The method of claim 24, further comprising:
providing a replacement order for an order that is ineligible for resurrection if approval is provided by at least one designated individual.

26. The method of claim 17, wherein the order was obtained from an online shopping website.

27. The method of claim 17, wherein the order was obtained by use of a telecommunication equipment.

28. An apparatus for resurrecting an order for a product or service, the apparatus comprising:
a view order status module configured to show a status of an order;
a resurrection request module configured to queue an order that has been requested for resurrection, where the resurrection request includes a comment indicating whether to accept or decline the resurrection request; and
a rule application module configured to accept, reject and purge a request for an order that has been stored in a queue in the resurrection request module.
